(19) United States
(12) Patent Application Publication
(10) Pub. No.: US 2008/0168826 A1
(43) Pub. Date: Jul. 17, 2008

(54) METHOD AND SYSTEM FOR GAS LEAK DETECTION AND LOCALIZATION

(75) Inventors: Ali Saidi, St. Charles, IL (US); Silviu Chiricescu, Chicago, IL (US); James M. Norris, Naperville, IL (US); Michael A. Schuette, Wilmette, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/623,892

(22) Filed: Jan. 17, 2007

(51) Int. Cl. G01M 3/04

(52) U.S. Cl. 73/40

(57) ABSTRACT

A system includes a first gas sensor [110] to detect a first concentration of a predetermined gas and to determine a first rate of change in the first concentration over a time interval. A second gas sensor [115] detects a second concentration of the predetermined gas and determines a second rate of change in the second concentration over the time interval. A third gas sensor [120] detects a third concentration of the predetermined gas and determines a third rate of change in the third concentration over the time interval. The first, second, and third gas sensors each have a known location. At least one processing device [510] (a) determines respective distances between a gas leak location and the respective locations of the gas sensors based on the detected rates of change, and (b) calculates a location of the gas leak based on a triangulation of the first distance, the second distance, and the third distance.

### TECHNICAL FIELD

This invention relates generally to a method and system for gas leak detection.

### BACKGROUND

Chemical factories, refineries, warehouses, and semiconductor fabrication laboratories sometimes process and/or transport dangerous gases. These gases can be flammable, such as natural gas or methane. Toxic gases are also sometimes produced as a result of a chemical reaction. Such gases are normally transported through a series of pipes or containers in the factories. Problems arise when the gas starts to leak out of the pipes or other containers, as this can result in a fire, explosion, or some other type of damage to the factories, workers, and/or equipment within such facilities.

According to some systems, leaks are commonly detected manually, and if there is a gas leak, the source can be difficult to pinpoint. To manually detect the source, a safety inspector or other authorized individual often walks around the facility in which the leak has occurred while holding a portable sensor device to attempt to detect the actual location of leakage.

Additional automated gas leak detection systems have been proposed. In one of the proposed systems, a series of gas sensors are utilized to detect a concentration of gas. In the event that the sensed concentration is greater than a pre-set threshold, an alarm is sounded. The gas sensors are currently spaced relatively close together. In the event of a gas leak, the gas sensors near the leak will each sound an alarm when the amount of gas leaking is greater than a pre-set threshold level. Manually reading sensor levels can be expensive and time consuming. Moreover, the current sensors are limited by the way in which they are deployed. If the sensor readings are taken manually, a gas leak cannot be resolved timely.

A problem with current solutions, however, is that potentially hundreds of gas sensors may be required for a large area being monitored. Current sensors that are spaced close together cannot, however, precisely resolve the location of a gas leak. More specifically, the current systems are only accurate to a margin of error equal to the distance between each sensor. This margin of error can be problematic when dealing with an area having multiple pipes or containers, as several pipes might need to be shut down and an inspector might have to manually locate the source of the leak. This can be very time-consuming and may require that the entire area be evacuated while the inspector searches for the exact source of the leak so that the leak can be repaired.

Wireless Sensor Networks (“WSNs”) are networks consisting of a large number of small, autonomous sensor devices equipped with processing and wireless communications capabilities. By taking advantage of miniaturization technologies, wireless sensor nodes are becoming an integral part of our environment and the ways in which we interact with it. Of the myriad applications enabled by WSNs, the ones dealing with monitoring, tracking, and control are the most common. These capabilities have the potential to greatly impact safety-related applications. In a typical safety application, the WSN performs one or more of the following: (a) monitoring and detecting of the environment for harmful events, (b) tracking the development of such events, and (c) initiating an action to respond to the harmful events.

There are commercially available sensors in the art for detecting different gases. One such sensor, integrated with a micro-controller and a communication module, could form a node of a WSN. Simply putting together a number of such nodes in a network, however, would only provide for the detection of the presence of a gas leak and its proximity to certain nodes. Therefore, a large number of nodes would again still be required to localize the leak source and determine the rate of gas emission.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a gas detection system according to at least one embodiment of the invention;

FIG. 2 illustrates a distance from a gas sensor to a gas leak according to at least one embodiment of the invention;

FIG. 3 illustrates a plot of detected gas concentration versus time according to at least one embodiment of the invention;

FIG. 4 illustrates a gas leak detected by three gas sensors according to at least one embodiment of the invention;

FIG. 5 illustrates a gas sensor according to at least one embodiment of the invention; and

FIG. 6 illustrates a method of determining a location of a gas leak according to at least one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

According to various embodiments described below, a gas leak detection system and method is provided that requires fewer gas sensors than the number of sensors deployed in current solutions and generates greater precision and timeliness in locating the source of a gas leak. Three or more gas sensors may monitor gas concentration levels in a given area. The physical distance between the gas sensors is a function of the sensitivity of the gas sensors. If highly sensitive gas sensors are used, the gas sensors may be placed further apart than would be possible if less sensitive gas sensors were used.

The gas sensors measure the concentration of gas surrounding each respective gas sensor. The gas sensors may wirelessly transmit such measurements to each other or to a server. In other embodiments wired gas sensors may be utilized. A person of skill in the art would readily appreciate, however, that cost savings may be achieved by utilizing wireless gas sensors because expensive infrastructure to wire the gas sensors together would therefore not be required.

Each of the gas sensors contain their own processing device and/or transmit signals corresponding to detected gas levels to an external processing device. In the event that, for example, a gas sensor contains a processing device, the gas is sensed or detected by the sensor and a corresponding electrical signal is generated based on the amount of gas detected in the air around the gas sensor. This electrical signal may indicate a concentration of the gas in terms of parts-per-million. The gas sensor contains or is in communication with a memory device. The electrical signals corresponding to the detected gas levels may be stored as a string of data in the memory device or in some other memory buffer. Such information is subsequently analyzed by a processor.

The processor measures a rate of change of the concentration of the gas for a given time interval. Based on the measured rate of change, the processor can determine how far away the gas leak is located. Measuring the distance in this manner is based on the diffusion properties of the sensed gas. That is, the further away from the gas leak, the lower the concentration of the gas will be at a given time and the slower the rate of increase of the concentration over a given time period. Gases tend to spread out in the air around a gas leak in approximately a spherical manner if there is no significant airflow. The areas closest to the gas leak will typically have the greatest concentration of the gas and experience the greatest rate of change of the concentration of the gas. As the distance from the gas leak increases, the concentration decreases by a factor proportional to about 1/R³, where R is the radius from the gas leak.

Because the properties of diffusion are physical laws, the distance from the gas leak is determined based on the rate of change of the concentration of the gas in the air over a given time interval. The closer the gas sensor is to the gas leak, the greater the rate of change, and the further away from the gas leak, the lower the rate of change. The rate of change may be compared against values of a look-up table to determine a distance from the gas leak corresponding to the rate of change. Alternatively, the distance may be mathematically determined via a gas concentration equation that may be executed by the processor.

The distance indicates the distance from the sensor to the gas leak. One distance measurement does not, however, indicate the exact location of the gas leak because the gas leak could be located anywhere in a 360° sphere around the sensor. If distances can be calculated for at least three different gas sensors, a substantially exact location of the gas leak may be determined via a triangulation method. Specifically, in the event that three radiuses/distances from the gas leak are known for each of three gas sensors, of two locations where these radiuses intersect, it is typically very easy to arrange the sensors so that only one of the two locations is logical, or a fourth sensor can be added to remove the ambiguity.

The intersection location is, of course, where the gas leak is located. Once the gas leak location is pinpointed, such location information may be sent to a server or some other device accessible by an inspector or warning system. Alternatively, raw sensor data may be sent directly to a server. The server may calculate the distances between the various sensors based on the raw data and may implement the triangulation method to pinpoint the location of the gas leak.

Such embodiments provide a number of advantages over current systems. For example, a precise location of the gas leak is determined while using fewer gas sensors than current systems. Moreover, the location of the gas leak is determined with greater accuracy than current systems, which have a relatively high margin of error. This can result in cost savings and a simpler system to maintain. Moreover, determining the rate of change of the gas concentration is further advantageous because the system can anticipate that the gas concentration will soon be above a dangerous threshold level and sound a warning before the threshold concentration level is reached. Many current systems, on the other hand, only sound an alarm after the dangerous concentration threshold level has already been reached.

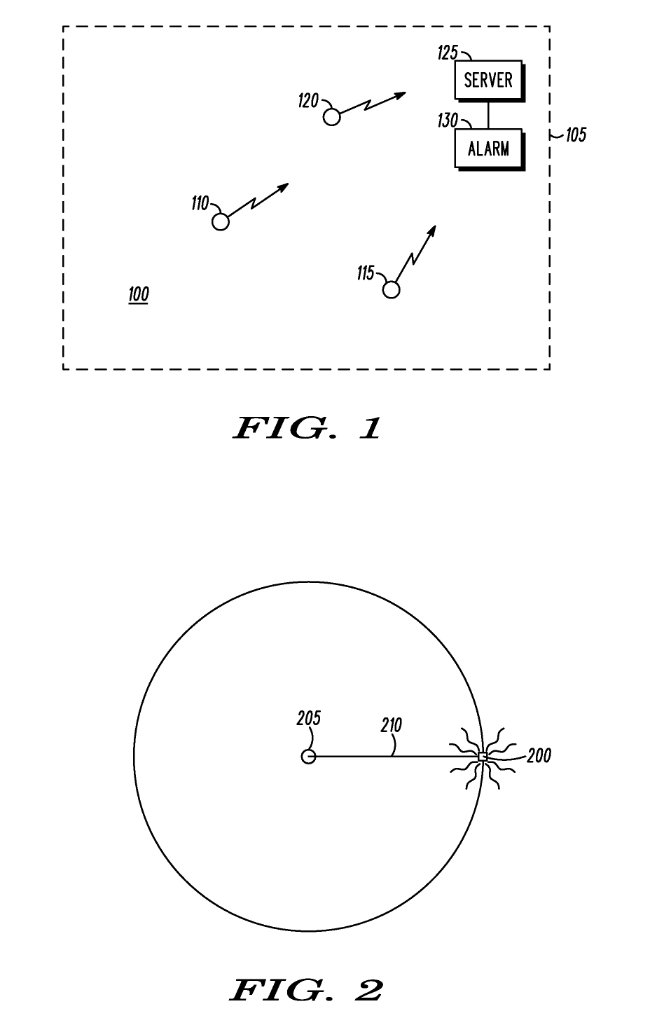

FIG. 1 illustrates a gas detection system 100 according to at least one embodiment of the invention. As shown, the gas detection system 100 monitors the gas level of one or more predetermined gases, such as hazardous, flammable, or otherwise dangerous gases, within a given area 105. The monitored gases may include, for example, methane and carbon monoxide. The gas detection system 100 includes a first sensor 110, a second sensor 115, and a third sensor 120. Additional gas sensors may also be used, depending upon the size of the area 105 being monitored and the size/sensitivity of the gas sensors. Another consideration in this regard may be the relative immediate danger posed by the gas, as it may be desirable to deploy a greater number of sensors when dealing with a gas that poses relatively great danger and where detection of the gas within a shortest amount of time is a primary concern.

The first sensor 110, the second sensor 115, and the third sensor 120 may be substantially evenly spaced in some embodiments, although this is not required. The first sensor 110, the second sensor 115, and the third sensor 120 may communicate wirelessly with each other and with a server 125. In alternative embodiments, the sensors and the server may instead be hard-wired to each other.

The first sensor 110, the second sensor 115, and the third sensor 120 detect gas levels and report their sensor readings to the server. The gas sensor measures a gas concentration in parts-per-million or similar unit of measure. In some embodiments, the sensors report the detected gas levels periodically. In other embodiments, the gas levels are reported only when they exceed a threshold detected gas concentration. In the event that the detected gas levels exceed a dangerous threshold level, the server 125 communicates with an alarm 130 which may audibly or visually initiate an alarm to indicate that the area 105, or a portion of the area 105, should be evacuated or that attention is otherwise warranted.

In the event that a gas leak is detected with the area 105, distances from each of the first sensor 110, the second sensor 115, and the third sensor 120 to the gas leak are respectively determined and a processor pinpoints the location of the gas leak based on a triangulation method, as discussed below with respect to FIG. 2. The triangulation method may be implemented by a processor within the server 125. Alternatively, the triangulation method may be implemented by a processor within one of the gas sensors.

FIG. 2 illustrates a distance from a gas sensor to a gas leak according to at least one embodiment of the invention. As shown, a gas sensor 205 detects the gas leak as the gas leaks from a gas leak location 200. The distance between the gas sensor 205 and the gas leak location 200 is indicated by the radius 210. The gas sensor 205 is able to determine the length of radius 210 but unable to determine the specific location on the sphere (shown as a circle for the sake of simplicity in FIG. 2) swept out by the radius 210 without information from adjacent gas sensors.

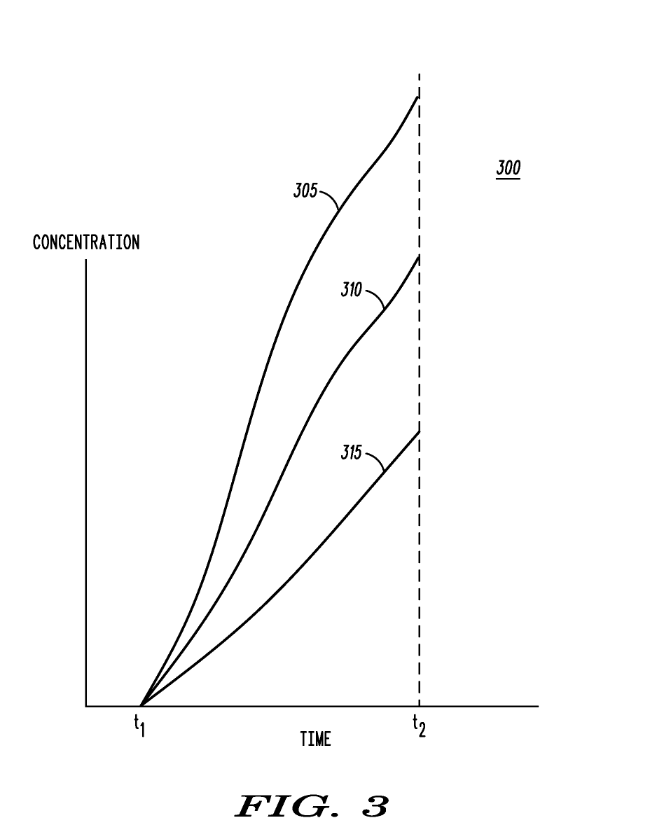

FIG. 3 illustrates a plot 300 of detected gas concentration versus time according to at least one embodiment of the invention. As discussed above, the rate of change of the gas concentration is greater the closer the gas sensor is to the gas leak. The rate of change is reflected by the slope of a data line on the plot 300. A first data line 305, a second data line 310, and a third data line 315 are shown in plot 300 of FIG. 3. Each of theses data lines are generated based on detected gas concentration levels when a gas leak begins at time t₁ and ends, or the measurements end, at time t₂. The first data line 305 is generated by a gas sensor located very close to a gas leak. The second data line 310 is generated by a gas sensor located father away. The third data line 315 is generated by a gas sensor located the farthest away. As shown, the slope (i.e., the increase in gas concentration for a given time period) of the first data line 305 is greater than the slope of the second data line 310, which in turn is greater than the slope of a third data line 315.

A processor may calculate the slope of each of these data lines and compare the slope with a pre-stored slope value in a lookup table. The lookup table maps various slopes with distances from a gas leak. Accordingly, based on the slope, the distance from the gas leak may be determined.

Alternatively, the following equation based on physical laws of diffusion and may be utilized to measure the distance from the gas leak:

C=[Ø/4πDr]*erfc*r/[2*(Dt)̂0.5]

where C is a gas concentration amount, Ø is a constant rate at which the gas is being released, erfc is a complimentary error function, D is a diffusion coefficient, and r is the distance from the gas source/leak at a time t.

Using a first order approximation to the derivative of the above-listed equation, the distance r can be written as a function of the slope of the rate of increase in gas concentration. The distance r is then obtained by using an estimate of the slope from the measured data at various gas sensors. Alternatively, both the calculation above and a lookup table may be utilized to calculate the distance to increase the accuracy of the estimates.

The above-listed equation may be utilized to measure the distance the from the gas leak when the air movement or flow is below a certain threshold such that it is substantially constant. The lookup table may be utilized to measure the distance regardless of the air movement. For the most precise measurement of the distance, the equation and the lookup table may both be utilized to measure the distance when the air movement is low. For example, the distances determined by the equation and via reference to the lookup table may be averaged to determine a potentially more accurate measurement of the distance.

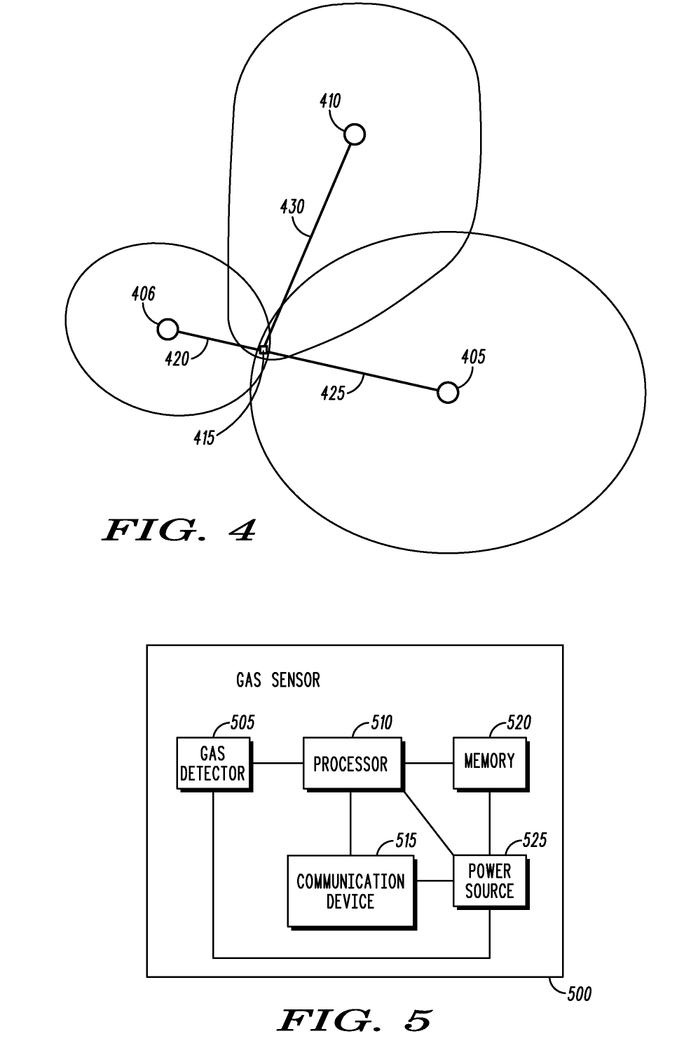

FIG. 4 illustrates a gas leak detected by three gas sensors according to at least one embodiment of the invention. As shown, a first sensor 400, a second gas sensor 405, and a third gas sensor 410 detect gas leaking from a gas leak location 415. Each of the sensors may determine their respective distance from the gas leak location 415 based on the rate of change of the detected gas concentration, as discussed above with respect to FIG. 3. The first gas sensor 400 determines that it is separated from the gas leak location 415 by a first distance 420. The second gas sensor 405 determines that it is separated from the gas leak location 415 by a second distance 425. The third gas sensor 410 determines that it is separated from the gas leak location 415 by a third distance 430.

In the event that there is a single gas leak location 415, the distance measurements from three or more gas sensors may be utilized to pinpoint the location of the gas leak location 415 via a triangulation method. More specifically, because the first gas sensor 400, the second gas sensor 410, and the third gas sensor 410 all have fixed locations, there is only one location where the first distance 420, the second distance 425, and the third distance 430 intersect. The point of intersection is the location of the gas leak location 415. There may be a small margin of error in each of the distance calculations. Accordingly, when determining the gas leak location 415, a small area where the gas leak is located may be determined as opposed to a specific pinpointed location.

It should be appreciated that more than three gas sensors may be utilized in determining the location of the gas leak location 415. In the event that four sensors are utilized, for example, distances would be determined between each of the gas sensors and the detected gas leak (or, if desired, by only using information as corresponds to a given selection of such sensors, such as the three sensors that sense the greatest concentrations of the gas). The triangulation method may subsequently be implemented on sets of three sensors and the calculated location may be averaged based on the distances calculated via the different sets of data.

FIG. 5 illustrates a gas sensor 500 according to at least one embodiment of the invention. As shown, the gas sensor 500 includes a gas detector 505, a processor 510, a communication device 515, a memory 520, and a power source 525, such as a battery. The gas detector 505 detects a concentration level of a predetermined gas in the air. The processor 510 may execute program code stored in the memory 520. The memory 520 may also be utilized to store readings of the gas detector 505. The processor 510 may utilize the stored sensor readings to determine a slope or rate of increase of the gas concentration level for a given time period. The memory 520 may also include a stored lookup table mapping various slopes in gas concentration levels to distances. The memory 520 may include the gas concentration equation discussed above with respect to FIG. 3 expressed as a program routine or program code stored in the memory 520 . . .

The power source 525 provides power to the processor 510, the gas detector 505, the communication device 515, and the memory 520. The communication device 515 may be utilized to send data or any other relevant information to any of the other gas sensors or the server. The communication device 515 may also be utilized to receive data or other information from the other gas sensors or the server.

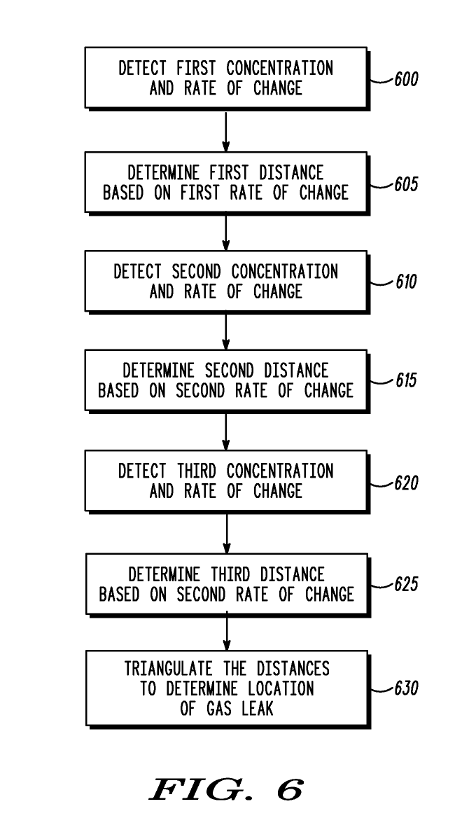

FIG. 6 illustrates a method of determining a location of a gas leak according to at least one embodiment of the invention. First, at operation 600, a first concentration of a predetermined gas is detected and a first rate of change of the first concentration is determined over a time interval. Next, at operation 605, a first distance between a first gas sensor and a gas leak is determined based on the first rate of change. As discussed above with respect to FIGS. 2 and 3, this distance may be determined by comparing the measured rate of change of the concentration with values in a lookup table or by using the equation discussed above with respect to FIG. 3. At operation 610, a second concentration of a predetermined gas is then detected and a second rate of change of the second concentration is determined over a time interval. Subsequently, at operation 615, a second distance between a second gas sensor and the gas leak is determined based on the second rate of change. Next, at operation 620, a third concentration of a predetermined gas is detected and a third rate of change of the second concentration is determined over a time interval. At operation 625, a third distance between a third gas sensor and the gas leak is then determined based on the third rate of change. Finally, at operation 630, the three distances are triangulated to determine the location of the gas leak.

The teachings described therein provide efficient and cost-effective techniques for accurately and precisely determining the location of a gas leak. The location of the gas leak can be determined with a relatively small number of nodes in a WSN and may provide early detection and warning.

For example, the methods described herein achieve superior localization resolution while requiring only a small number of sensors arranged in a sparsely populated grid. As such, these techniques significantly reduce the deployment costs of such a gas detection safety system. This differs from current gas detection systems which provide only gas concentration readings but which are not capable of detecting rates of emission.

Techniques described herein are capable of predicting emission rates without employing different types of sensors. Gas sensor nodes of current systems provide only instantaneous readings of gas concentration and are incapable of predicting future gas concentrations. According to the teachings herein, on the other hand, future gas concentrations may be determined based on a regression technique by measuring the rate of increase of gas concentration (i.e., the slope of the rate of change of gas concentration). Based on the rate of increase, the future gas concentration may be estimated, assuming that conditions do not change in the future assuming the conditions relating to the gas leak do not change.

The techniques described herein account for gas dissipation in a given medium and, as such, a WSN which includes such techniques is capable of estimating future gas concentration providing invaluable early detection of a gas leak. For example, in the event that a relatively large rate of change of gas concentration is detected, an alarm can be initiated even though the gas concentration has not yet reached a hazardous threshold because the rate of change is used to estimate the gas concentration at some point in the near future.

Those skilled in the art will recognize and appreciate that these teachings can be applied in various ways and are readily leveraged in a variety of application settings. It will also be understood and appreciated that these teachings can be relatively economically facilitated and are highly scalable in practice.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, in some cases, a given sensor may be located in an area that is proximal to some condition, such as an operating fan, that will tend to increase or reduce the opportunity of that sensor to detect a gas. In such a case, if desired, one could provide a weighting factor (or factors) to reflect and accommodate such an operating environment when making the above-described calculations.

We claim:

1. A system, comprising:
a first gas sensor, having a first predetermined location, to detect a first concentration of a predetermined gas and determine a first rate of change in the first concentration over a time interval;
a second gas sensor, having a second predetermined location, to detect a second concentration of the predetermined gas and determine a second rate of change in the second concentration over the time interval;
at least a third gas sensor, having a third predetermined location, to detect a third concentration of the predetermined gas and determine a third rate of change in the third concentration over the time interval; and
at least one processing device to
determine a first distance from the first predetermined location to a gas leak based on the first rate of change, a second distance from the second predetermined location to the gas leak based on the second rate of change, and a third distance from the third predetermined location to the gas leak based on the third rate of change; and
calculate a location of the gas leak based on a triangulation of the first distance, the second distance, and the third distance.

2. The system of claim 1, wherein the at least one processing device comprises a single processing device.

3. The system of claim 1, further comprising a transmission device to transmit the location of the gas leak to a server.

4. The system of claim 1, further comprising an alarm to indicate a warning in response to any of the first rate of change, the second rate of change, and the third rate of change exceeding a predetermined threshold level.

5. The system of claim 1, further comprising a memory to store a lookup table, wherein the at least one processing device utilizes the lookup table to determine the first distance corresponding to the first rate of change stored in the lookup table, the second distance corresponding to the second rate of change stored in the lookup table, and the third distance corresponding to the third rate of change stored in the lookup table.

6. The system of claim 1, wherein in response to a detected air movement near the first gas sensor, the second gas sensor, and the third gas sensor being below a predetermined threshold amount the at least one processing device is adapted to utilize a gas diffusion equation to determine at least one of: the first distance between the first gas sensor and the gas leak based on the first rate of change, the second distance between the second gas sensor and the gas leak based on the second rate of change, and the third distance between the at least the third gas sensor and the gas leak based on the third rate of change.

7. The system of claim 1, further comprising at least a fourth gas sensor, having a fourth predetermined location, to detect a fourth concentration of the predetermined gas and determine a fourth rate of change in the fourth concentration over the time interval.

8. The system of claim 8, wherein the processing device is further adapted to determine a fourth distance from the fourth predetermined location and the gas leak based on the fourth rate of change, and
wherein the location of the gas leak is further determined based on an averaging of the triangulation based on the first distance, the second distance, the third distance and a second triangulation based on the fourth distance and two of first distance, the second distance, the third distance.

9. A method, comprising:
detecting a first concentration of a predetermined gas, determining a first rate of change in the first concentration over a time interval, and determining a first distance from a first gas sensor having a first predetermined location and a gas leak based on the first rate of change;
detecting a second concentration of the predetermined gas, determining a second rate of change in the second concentration over the time interval, and determining a second distance from a second gas sensor having a second predetermined location and the gas leak based on the second rate of change;
detecting a third concentration of the predetermined gas, determining a third rate of change in the third concentration over the time interval, and determining a third distance from at least a third gas sensor having a third predetermined location and the gas leak based on the third rate of change; and
calculating a location of the gas leak based on a triangulation of the first distance, the second distance, and the third distance.

10. The method of claim 9, further comprising wirelessly communicating at least one of the first distance, the second distance, and the third distance.

11. The method of claim 9, further comprising transmitting the location of the gas leak to a server.

12. The method of claim 9, further comprising generating an alarm indication in response to any of the first rate of change, the second rate of change, and the third rate of change exceeding a predetermined threshold level.

13. The method of claim 9, further comprising referring to lookup table in a memory to determine the first distance corresponding to the first rate of change stored in the lookup table, the second distance corresponding to the second rate of change stored in the lookup table, and the third distance corresponding to the third rate of change stored in the lookup table.

14. The method of claim 9, further comprising detecting a fourth concentration of the predetermined gas, determining a fourth rate of change in the fourth concentration over the time interval, and determining a fourth distance from at least the fourth gas sensor having a fourth predetermined location and the gas leak based on the fourth rate of change.

15. The method of claim 14, wherein the calculating further comprises averaging the triangulation based on the first distance, the second distance, the third distance and a second triangulation based on the fourth distance and two of first distance, the second distance, the third distance to further determine the location.

16. The method of claim 9, further comprising predicting a future gas concentration based on a least one of the determined a first rate of change in the first concentration, the second rate of change in the second concentration, and the third rate of change in the third concentration over the time interval

17. A gas sensor, comprising:
a gas detector to detect a concentration of at least one predetermined gas;
a processor to determine
a rate of change of the concentration over a time interval; and
a distance between the gas detector having a known location and a gas leak based on the rate of change; and
a communication device to communicate at least the distance to at least one of a second gas sensor and a server.

18. The gas sensor of claim 17, wherein the communication device is adapted to communicate at least one of wirelessly and via a wired connection.

19. The gas sensor of claim 17, further comprising a memory to store a lookup table, wherein the processor utilizes the lookup table to determine the distance from the gas sensor to the gas leak based on the rate of change.

20. The gas sensor of claim 17 wherein the processor is adapted to utilize a gas diffusion equation to determine the distance from the gas sensor to the gas leak based on the rate of change in response to a detected air movement near the gas sensor being below a predetermined threshold amount.
